(19) United States
(12) Patent Application Publication
(10) Pub. No.: US 2021/0179653 A1
(43) Pub. Date: Jun. 17, 2021

(54) REDOX REVERSIBLE FLUORESCENT PROBE AND PERFORMING SINGLE-ELECTRON TRANSFER FLUORESCENCE PROBING

(71) Applicant: Government of the United States of America, as represented by the Secretary of Commerce, Gaithersburg, MD (US)

(72) Inventors: Jeremiah Wallace Woodcock, Gaithersburg, MD (US); Douglas Matthew Fox, Reston, VA (US); Veronika Ann Szalai, Gaithersburg, MD (US)

(21) Appl. No.: 17/113,228

(22) Filed: Dec. 7, 2020

Related U.S. Application Data
(60) Provisional application No. 62/948,933, filed on Dec. 17, 2019.

(51) Int. Cl. C07F 17/02; C09K 11/07; G01N 21/77

(52) U.S. Cl. CPC C07F 17/02; C09K 11/07; G01N 21/77; G01N 2021/7786; C09K 2211/1491; C09K 2211/1007; C09K 2211/187

(57) ABSTRACT

A redox reversible fluorescent probe for performing single-electron transfer fluorescence probing includes: a redox moiety including: a terminal moiety; an electron transfer metal coordinatively bonded to the terminal moiety; and a bridge moiety coordinatively bonded to the electron transfer metal; and a fluorescent moiety covalently bonded to the bridge moiety of the redox moiety and comprising: an electron bandgap mediator that is covalently bonded to the bridge moiety; a coordinate center covalently bonded to the electron bandgap mediator and that forms a Zwitterionic member with an atom in the electron bandgap mediator; and a steric hinder bonded to the electron bandgap mediator to provide steric hindrance for protection of the coordinate center.

### CROSS REFERENCE TO RELATED APPLICATIONS

The application claims priority to U.S. Provisional Patent Application Ser. No. 62/948,933 filed Dec. 17, 2019, the disclosure of which is incorporated herein by reference in its entirety.

### STATEMENT REGARDING FEDERALLY SPONSORED RESEARCH

This invention was made with United States Government support from the National Institute of Standards and Technology (NIST), an agency of the United States Department of Commerce. The Government has certain rights in the invention. Licensing inquiries may be directed to the Technology Partnerships Office, NIST, Gaithersburg, Md., 20899; voice (301) 301-975-2573; email tpo@nist.gov; reference NIST Docket Number 19-046US1.

### BRIEF DESCRIPTION

Disclosed is a redox reversible fluorescent probe for performing single-electron transfer fluorescence probing, the redox reversible fluorescent probe comprising: a redox moiety comprising: a terminal moiety; an electron transfer metal coordinatively bonded to the terminal moiety; and a bridge moiety coordinatively bonded to the electron transfer metal; and a fluorescent moiety covalently bonded to the bridge moiety of the redox moiety and comprising: an electron bandgap mediator that is covalently bonded to the bridge moiety; a coordinate center covalently bonded to the electron bandgap mediator and that forms a Zwitterionic member with an atom in the electron bandgap mediator; and a steric hinder bonded to the electron bandgap mediator to provide steric hindrance for protection of the coordinate center.

### BRIEF DESCRIPTION OF THE DRAWINGS

The following description should not be considered limiting in any way. With reference to the accompanying drawings, like elements are numbered alike,

FIG. 1 shows structures of a redox reversible fluorescent probe, terminal moiety, electron transfer metal, bridge moiety, and fluorescent moiety;

FIG. 2 shows a structure of redox reversible fluorescent probe;

FIG. 3 shows a structure of redox reversible fluorescent probe;

FIG. 4 shows a HOMO-to-LUMO electronic transition for a redox reversible fluorescent probe at 310 nm;

FIG. 5 shows a HOMO-to-LUMO electronic transition for a redox reversible fluorescent probe at 120 nm;

FIG. 6 shows a graph of intensity versus excitation wavelength and emission wavelength for a redox reversible fluorescent probe;

FIG. 7 shows a graph of excitation wavelength versus emission wavelength for a redox reversible fluorescent probe; and

FIG. 8 shows a graph of redox potential versus electron transfer metal for a redox reversible fluorescent probe.

### DETAILED DESCRIPTION

A detailed description of one or more embodiments is presentee herein by way of exemplification and not limitation.

Industrial electrochemical processes benefit from improved efficiency and better fundamental understanding. Improved battery performance involves accessible, precise metrology for their development. Conventional fabrication of fluorescent probes adaptable to electrochemical systems have encountered unsolved technological problems and limitations that involve deficiencies with broad electrochemical stability, reversible behavior, or efficient kinetics. Conventional probes lack applicability to single electron processes and are operable in multi-electron transfer electrochemistry such as from two to six electron transfer processes that can be detrimentally susceptible to side reactions. A redox reversible fluorescent probe and process for performing single-electron transfer fluorescence probing described herein overcomes the technological problems, limitations, and deficiencies of conventional technology. The A redox reversible fluorescent probe and process for performing single-electron transfer fluorescence probing have a high quantum yield so that a very small quantity of the redox reversible fluorescent probe can be used in performing single-electron transfer fluorescence probing. Advantageously, the redox reversible fluorescent probe can be made in a one-pot synthesis.

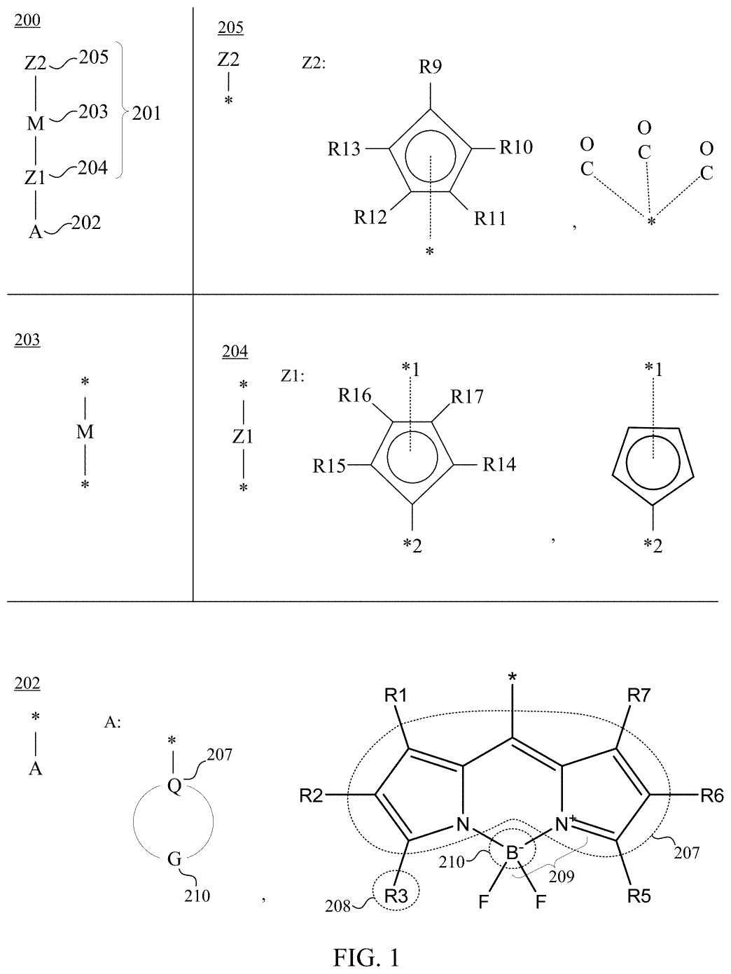

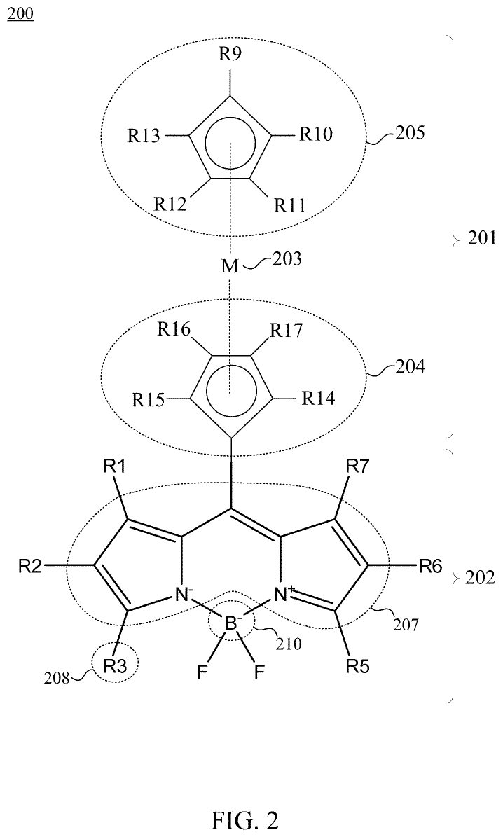

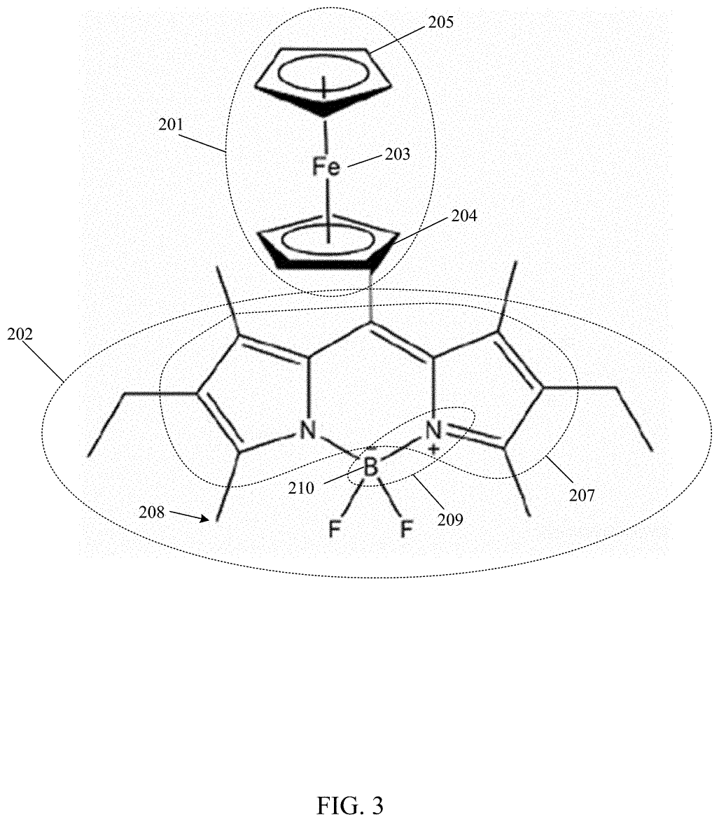

Redox reversible fluorescent probe 200 can be used for performing single-electron transfer fluorescence probing. In an embodiment, with reference to FIG. 1 FIG. 2, and FIG. 3, redox reversible fluorescent probe 200 includes: redox moiety 201 including: terminal moiety 205; electron transfer metal 203 coordinatively bonded to terminal moiety 205; and bridge moiety 204 coordinatively bonded to electron transfer metal 203; and fluorescent moiety 202 covalently bonded to bridge moiety 204 of redox moiety 201 and including: electron bandgap mediator 207 that is covalently bonded to bridge moiety 204; coordinate center 210 covalently bonded to electron bandgap mediator 207 and that forms Zwitterionic member 209 with an atom in electron bandgap mediator 207; and steric hinder 208 bonded to electron bandgap mediator 207 to provide steric hindrance for protection of coordinate center 210.

In an embodiment, a structure of redox reversible fluorescent probe 200 is

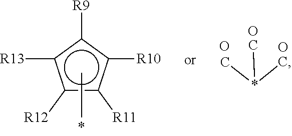

wherein Z2 is terminal moiety 205; M is electron transfer metal 203; Z1 is bridge moiety 204; and A is fluorescent moiety 202,

In an embodiment, a structure of terminal moiety 205 includes

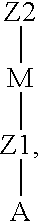

wherein * is a point of attachment to the bridge moiety 204; R9, R10, R11, R12, and R13 are independently H. an alkyl group, alkenyl group, alkynyl group, hydroxyalkyl group, or substituted version thereof; or any of R9, R10, R11, R12, and R13, together with the carbon atom to which they are attached, forms a monocyclic ring, a bicyclic ring, or a spirocyclic ring that optionally contains a heteroatom, and is optionally substituted. In an embodiment, terminal moiety 205 is

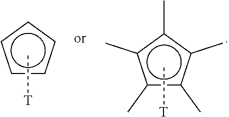

In an embodiment, electron transfer metal 203 includes V, Cr, Mn, Fe, Co, and Ni. According to an embodiment, electron transfer metal 203 is Fe.

In an embodiment, bridge moiety 204 includes

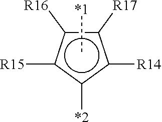

wherein *1 is a point of attachment to electron transfer metal 203; *2 are points of attachment to fluorescent moiety 202; and R14, R15, R16, and R17 are independently H, an alkyl group, alkenyl group, alkynyl group, hydroxyalkyl group, or substituted version thereof; or any of R_{14,} R_{15,} R16, and R17, together with the carbon atom to which they are attached, forms a monocyclic ring, a bicyclic ring, or a spirocyclic ring that optionally contains a heteroatom, and is optionally substituted. In an embodiment, R14, R15, R16, and R17 are independently H or CH₃. In an embodiment, bridge moiety 204 is

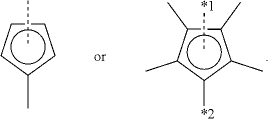

In an embodiment, a structure of fluorescent moiety 202 is

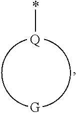

wherein Q is electron bandgap mediator 207; G is coordinate center 210; and * is a point of attachment to bridge moiety 204. Electron bandgap mediator 207 can include a conjugated electronic system that affects an electronic structure of redox moiety 201 and fluorescence emission wavelength of redox reversible fluorescent probe 200. The conjugated electronic system of electron bandgap mediator 207 can include alternating multiple bonds and single bonds, wherein the multiple bonds can include a double bond or a triple bond. Moreover, electron bandgap mediator 207 can include a cyclic ring, e.g., a monocyclic ting, a bicyclic ring, or tricyclic ring, and the like so that an extent of conjugation can be selected. In an embodiment, a structure of electron bandgap mediator 207 includes

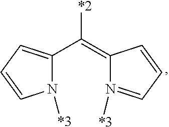

wherein *2 is a point of attachment to bridge moiety 204, and *3 are points of attachment to coordinate center 210. In an embodiment, electron bandgap mediator 207 and steric hinder 208 of fluorescent moiety 202 in combination include

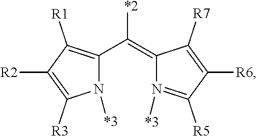

wherein *2 is a point of attachment to bridge moiety 204; *3 are points of attachment to coordinate center 210; and R₁, R₂, R₃, R₅, R₆, and R₇ are steric hinders 208 and are independently alkyl group, alkenyl group, alkynyl group, hydroxyalkyl group, or substituted version thereof; or any of R₁, R₂, R₃, R₅, R₆, and R₇, together with the carbon atom to which they are attached in electron bandgap mediator 207, forms a monocyclic ring, a bicyclic ring, or a spirocyclic ring that optionally contains a heteroatom, and is optionally substituted, such that if present the monocyclic ring, the bicyclic ring, or the spirocyclic ring optionally extends conjugation of electron bandgap mediator 207. In an embodiment, steric hinder 208 comprises an alkyl group that can be substituted. In an embodiment, electron bandgap mediator 207 and steric hinder 208 of fluorescent moiety 202 in combination includes

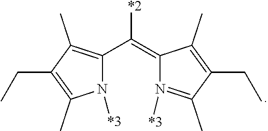

In an embodiment, coordinate center 210 includes boron. The boron is coordinated to electron bandgap mediator 207 at attachment points *3. Atoms external to electron bandgap mediator 207 can he bonded to the boron and can include a halogen such as fluorine. Accordingly, in an embodiment, electron bandgap mediator 207, steric hinder 208, and coordinate center 210 of fluorescent moiety 202 in combination include

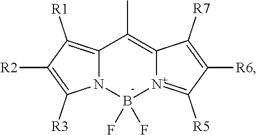

wherein * is a point of attachment to bridge moiety 204; and R1, R2, R3, R5, R6, and R7 are independently an alkyl group, alkenyl group, alkynyl group, hydroxyalkyl group, or substituted version thereof; or any of R1, R2, R3, R5, R6, and R7, together with the carbon atom to which they are attached, forms a monocyclic ring, a bicyclic ring, or a spirocyclic ring that optionally contains a heteroatom, and is optionally substituted, such that if present the monocyclic ring, the bicyclic ring, or the spirocyclic ring optionally extends conjugation of electron bandgap mediator 207. In an embodiment, fluorescent moiety 202 is

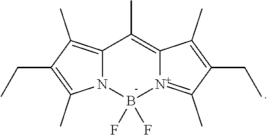

In an embodiment, redox reversible fly orescent probe 200 is

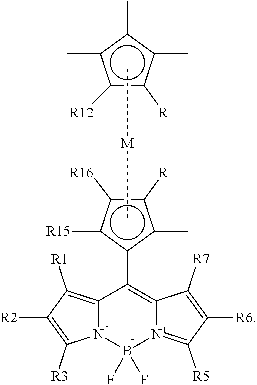

In an embodiment, redox reversible fluorescent probe 200 is

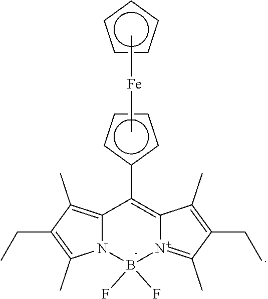

In an embodiment, redox reversible fluorescent probe 200 is meso ferrocene Bodipy.

Where a compound exists in various tautomeric forms, redox reversible fluorescent probe 200 is not limited to any one of the specific tautomers, but rather includes all tautomeric forms.

Redox reversible fluorescent probe 200 is intended to include all isotopes of atoms occurring in the present compounds. Isotopes include those atoms having the same atomic number but different mass numbers. By way of general example, and without limitation, isotopes of hydrogen include tritium and deuterium and isotopes of carbon include ¹¹C, ¹³C, and ¹⁴C.

Certain compounds are described herein using a general formula that includes variables, e.g., A, R1, R2, R3, R5, R7, R10, and the like. Unless otherwise specified, each variable within such a formula is defined independently of other variables. Thus, if a group is said to be substituted, e.g. with 0-2 R*, then said group may be substituted with up to two R* groups and R* at each occurrence is selected independently from the definition of R*. Also, combinations of substituents or variables are permissible only if such combinations result in stable compounds. When a group is substituted by an “oxo” substituent, a carbonyl bond replaces two hydrogen atoms on a carbon. An “oxo” substituent on an aromatic group or heteroaromatic group destroys the aromatic character of that group, e.g. a pyridyl substituted with oxo is a pyridone.

The term “substituted,” as used herein, means that any one or more hydrogens on the designated atom or group is replaced with a selection from the indicated group, provided that the designated atom's normal valence is not exceeded. When a substituent is oxo (i.e., ═O), then 2 hydrogens on the atom are replaced. Combinations of substituents or variables are permissible only if such combinations result in stable compounds or useful synthetic intermediates. A stable compound or stable structure is meant to imply a compound that is sufficiently robust to survive isolation from a reaction mixture, and subsequent formulation into redox reversible fluorescent probe 200. Unless otherwise specified, substituents are named into the core structure. For example, it is to be understood that when (cycloalkyl)alkyl is listed as a possible substituent the point of attachment of this substituent to the core structure is in the alkyl portion.

The exception to naming substituents into the ring is when the substituent is listed with a dash (“-”) or double bond (“═”) that is not between two letters or symbols. that case the dash or double bond symbol is used to indicate a point of attachment for a substituent. For example, —CONH₂ is attached through the carbon atom.

As used herein, “alkyl” is intended to include both branched and straight-chain saturated aliphatic hydrocarbon groups, having the specified number of carbon atoms. Thus, the term C₁-C₆ alkyl as used herein includes alkyl groups having from 1 to about 6 carbon atoms. When C₀-Cₙ alkyl is used herein in conjunction with another group, for example, (aryl)C₀-C₄ alkyl, the indicated group, in this case aryl, is either directly bound by a single covalent bond (C₀), or attached by an alkyl chain having the specified number of carbon atoms, in this case from 1 to about 4 carbon atoms. Examples of alkyl include, but are not limited to, methyl, ethyl, n-propyl, isopropyl, n-butyl, t-butyl, n-pentyl, and sec-pentyl.

“Alkenyl” as used herein, indicates a hydrocarbon chain of either a straight or branched configuration having one or more carbon-carbon double bond bonds, which may occur at any stable point along the chain. Examples of alkenyl groups include ethenyl and propenyl.

“Alkynyl” as used herein, indicates a hydrocarbon chain of either a straight or branched configuration having one or more triple carbon-carbon bonds that may occur in any stable point along the chain, such as ethynyl and propynyl.

“Hydroxyalkyl” represents an alkyl group as defined above with the indicated number of carbon atoms with an alcohol functionality. Examples of hydroxyalkyl include, but are not limited to, hydroxymethyl, hydroxyethyl, hydroxy-n-propyl, hydroxy-i-propyl, hydroxyl-n-butyl, hydroxy-2-butyl, 2-hydroxy-2-methylpropyl, hydroxy-n-pentyl, hydroxy-2-pentyl, hydroxy-3-pentyl, hydroxyisopentyl, hydroxyneopentyl, hydroxy-n-hexyl, hydroxy-2-hexyl, hydroxy-3-hexyl, and hydroxy-3-methylpentyl.

As used herein, the term “aryl” indicates aromatic groups containing only carbon in the aromatic ring or rings. Typical aryl groups contain 1 to 3 separate, fused, or pendant rings and from 6 to about 18 ring atoms, without heteroatoms as ring members. When indicated, such aryl groups may be further substituted with carbon or non-carbon atoms or groups. Such substitution may include fusion to a 5- to 7-membered saturated cyclic group that optionally contains 1 or 2 heteroatoms independently chosen from N, O, and S, to form, for example, a 3,4-methylenedioxy-phenyl group. Aryl groups include, for example, phenyl, naphthyl, including 1-naphthyl and 2-naphthyl, and bi-phenyl.

“Cycloalkyl,” as used herein, indicates a saturated hydrocarbon ring group, having only carbon ring atoms and having the specified number of carbon atoms, usually from 3 to about 8 ring carbon atoms, or from 3 to about 7 carbon atoms. Examples of cycloalkyl groups include cyclopropyl, cyclobutyl, cyclopentyl, or cyclohexyl as well as bridged or caged saturated ring groups such as norborane or adamantane. Examples of (cycloalkyl)alkyl include, but are not limited to, cyclopropylmethyl, cyclohexylmethyl, cyclohexylpropenyl, and cyclopentylethyoxy.

“Cycloalkenyl” as used herein, indicates an unsaturated, but not aromatic, hydrocarbon ring having at least one carbon-carbon double bond. Cycloalkenyl groups contain from 4 to about 8 carbon atoms, usually from 4 to about 7 carbon atoms. Examples include cyclohexenyl and cyclobutenyl. Examples of (cycloalkenyl)alkyl include, but are not limited to, cyclobutenylmethyl, cyclohexenylmethyl, and cyclohexylpropenyl.

“Haloalkyl” indicates both branched and straight-chain saturated aliphatic hydrocarbon groups having the specified number of carbon atoms, substituted with 1 or more halogen atoms, generally up to the maximum allowable number of halogen atoms. Examples of haloalkyl include, but are not limited to, trifluoromethyl, difluoromethyl, 2-fluoroethyl, and pentafluoroethyl.

“Halo” or “halogen” as used herein refers to fluoro, chloro, bromo, or iodo.

As used herein, “heteroaryl” indicates a stable 5- to 7-membered monocyclic or 7- to 10-membered bicyclic heterocyclic ring which contains at least 1 aromatic ring that contains from 1 to 4. or preferably from 1 to 3, heteroatoms chosen from N, O, and S, with remaining ring atoms being carbon. When the total number of S and O atoms in the heteroaryl group exceeds 1, these heteroatoms are not adjacent to one another. It is preferred that the total number of S and O atoms in the heteroaryl group is not more than 2. It is particularly preferred that the total number of S and O atoms in the heteroaryl group is not more than 1. A nitrogen atom in a heteroaryl group may optionally be quaternized. When indicated, such heteroaryl groups may be further substituted with carbon or non-carbon atoms or groups. Such substitution may include fusion to a 5 to 7-membered saturated cyclic group that optionally contains 1 or 2 heteroatoms independently chosen from N, O, and S, to form, for example, a [1,3]dioxolo[4,5-c]pyridyl group. Examples of heteroaryl groups include, but are not limited to, pyridyl, indolyl, pyrimidinyl, pyridizinyl, pyrazinyl, imidazolyl, oxazolyl, (uranyl, thiophenyl, thiazolyl, triazolyl, tetrazolyl, isoxazolyl, quinolinol, pyrrolyl, pyrazolyl, benz[b]thiophenyl, isoquinolinyl, quinazolinyl, quinoxalinyl, thienyl, isoindolyl, and 5,6,7,8-tetra.hydroisoquinoline.

The term “heterocycloalkyl” indicates a saturated cyclic group containing from 1 to about 3 heteroatoms chosen from N, O, and S, with remaining ring atoms being carbon. Heterocycloalkyl groups have from 3 to about 8 ring atoms, and more typically have from 5 to 7 ring atoms. Examples of heterocycloalkyl groups include morpholinyl, piperazinyl, piperidinyl, and pyrrolidinyl groups, A nitrogen in a heterocycloalkyl group may optionally be quaternized. An “N-linked heterocycloalkyl” group is attached to the group it substitutes via a ring nitrogen.

“Heterocycloalkenyl” as used herein, indicates an unsaturated, but not aromatic, hydrocarbon ring having at least one carbon-carbon double bond. Heterocycloalkenyl groups contain from 4 to about 8 ring atoms, usually from 4 to about 7 ring atoms in which 1 to 3 ring atoms are chosen from N, O, and S, with remaining ring atoms being carbon.

The term “heterocyclic group” indicates a 5-6 membered saturated, partially unsaturated, or aromatic ring containing from 1 to about 4 heteroatoms chosen from N, O, and S, with remaining ring atoms being carbon or a 7-10 membered bicyclic saturated, partially unsaturated, or aromatic heterocylic ring system containing at least 1 heteroatom in the two ring system chosen from N, O, and S and containing up to about 4 heteroatoms independently chosen from N, O, and S in each ring of the two ring system. Unless otherwise indicated, the heterocyclic ring may be attached to its pendant group at any heteroatom or carbon atom that results in a stable structure. When indicated the heterocyclic rings described herein may be substituted on carbon or on a nitrogen atom if the resulting compound is stable. A nitrogen atom in the heterocycle may optionally be quaternized. It is preferred that the total number of heteroatoms in a heterocyclic group is not more than 4 and that the total number of S and O atoms in a heterocyclic group is not more than 2, more preferably not more than 1. Examples of heterocyclic groups include, pyridyl, indolyl, pyrimidinyl, pyridizinyl, pyrazinyl, imidazolyl, oxazolyl, furanyl, thiophenyl, thiazolyl, triazolyl, tetrazolyl, isoxazolyl, quinolinyl, pyrazolyl, benz[b]thiophenyl, isoquinolinyl, quinazolinyl, quinoxalinyl, thienyl, isoindolyl, dihydroisoindolyl, 5,6,7,8-tetrahydroisoquinoline, pyridinyl, pyrimidinyl, furanyl, thienyl, pyrrolyl, pyrazolyl, pyrrolidinyl, morpholinyl, piperazinyl, piperidinyl, and pyrrolidinyl.

Additional examples of heterocyclic groups include, but are not limited to, phthalazinyl, oxazolyl, indolizinyl, indazolyl, benzothiazolyl, benzimidazolyl, benzothranyl, benzoisoxolyl, dihydro-benzodioxinyl, oxadiazolyl, thiadiazolyl, triazolyl, tetrazolyl, oxazolopyridinyl, imidazopyridinyl, isothiazolyl, naphthyridinyl, cinnolinyl, carbazolyl, beta-carbolinyl, isochromanyl, chromanonyl, chromanyl, tetrahydroisoquinolinyl, isobenzotetrahydrofuranyl, isobenzotetrahydrothienyl, isobenzothienyl, benzoxazolyl, pyridopyridinyl, benzomrahydrofuranyl, benzotetrahydrothienyl, purinyl, benzodioxolyl, triazinyl, phenoxazinyl, phenothiazinyl, 5 pteridinyl, benzothiazolyl, imidazopyridinyl, imidazothiazolyl, dihydrobenzisoxazinyl, benzisoxazinyl, benzoxazinyl, dihydrobenzisothiazinyl, benzopyranyl, benzothiopyranyl, coumarinyl, isocoumarinyl, chromanyl, tetrahydroquinolinyl, dihydroquinolinyl, dihydroquinolinonyl, dihydroisoquinolinonyl, dihydrocoumarinyl, dihydroisocoumarinyl, isoindolinonyl, benzodioxanyl, benzoxazolinonyl, pyrrolyl N-oxide, pyrimidinyl N-oxide, pyridazinyl N-oxide, pyrazinyl N-oxide, quinolinyl N-oxide, indolyl N-oxide, indolinyl N oxide, isoquinolyl N-oxide, quinazolinyl N-oxide, quinoxalinyl N-oxide, phthalazinyl N-oxide, imidazolyl N-oxide, isoxazolyl N-oxide, oxazolyl N-oxide, thiazolyl N-oxide, indolizinyl N oxide, indazolyl N-oxide, benzothiazolyl N-oxide, benzimidazolyl N-oxide, pyrrolyl N-oxide, oxadiazolyl N-oxide, thiadiazolyl N-oxide, tetrazolyl N-oxide, benzothiopyranyl S-oxide, and benzothiopyranyl S,S-dioxide.

in redox reversible fluorescent probe 200, “monocyclic ring,” “bicyclic ring,” or “spirocyclic ring” independently can include a heteroatom in such ring, aryl, cycloalkyl, cycloalkenyl, heteroaryl, heterocycloalkyl, heterocycloalkenyl or can be substituted with an alkyl, alkenyl, alkynyl, hydroxyalkyl, aryl, haloalkyl, halo, or heterocyclic group.

Redox reversible fluorescent probe 200 can be made in various ways, In an embodiment, a process for making redox reversible fluorescent probe 200 includes: disposing, in a nitrogen-purged two necked flask, 3-ethyl-2,4-dimethyl pyrrole and methylene chloride to form a pyrrole composition; adding, to the pyrrole composition, ferrocenoyl chloride dissolved in methylene chloride; stirring the pyrrole composition for a select period, e.g., 24 hours; adding diisopropylethylamine to the flask to form a reaction composition; stirring the reaction composition for a selected period, e.g., 0.5-hour; cooling the reaction composition, e.g., by disposing the flask in an ice bath; adding borontrifluoride etherate to the reaction composition; stirring the reaction composition for another select period, e,g., 4 hours; dispersing the reaction composition in methylene; washing with sodium bicarbonate and subsequently deionized water to form meso ferrocene Bodipy as redox reversible fluorescent probe 200; and optionally isolating meso ferrocene Bodipy, e.g., by column chromatography with an extraction composition that can include, e.g., 1:1:3 by volume chloroform: ethyl acetate: hexanes. It should be appreciated that various reagents can be used in the process to form a particular electron bandgap mediator 207. In an embodiment, instead of using ferrocenoyl chloride in the process, ferrocencecarboxylic acid coupled with oxalic chloride or other similar reagent can be used, e.g., starting from ferrocene caroboxaldehyde with an acid catalyst to include Cp* (i.e., permethylated cyclopentadiene) in electron bandgap mediator 207.

The process for making redox reversible fluorescent probe 200 can include isolating a dipyrrin core prior to reaction with borontrifluoride etherate. Without wishing to be bound by theory, it is believed that such isolation can increase yield of electron bandgap mediator 207.

Compounds of redox reversible fluorescent probe 200 can be prepared according to methods well-known to those skilled in the art of organic chemical synthesis. The starting materials used in preparing the compounds of the invention are known, made by known methods, or are commercially available.

It is recognized that the skilled artisan in the art of organic chemistry can readily carry out standard manipulations of organic compounds without further direction.

The skilled artisan will readily appreciate that certain reactions are best carried out when other functionalities are masked or protected in the compound, thus increasing the yield of the reaction or avoiding any undesirable side reactions. Often, the skilled artisan uses protecting groups to accomplish such increased yields or to avoid the undesired reactions. These reactions are found in the literature and are also well within the scope of the skilled artisan.

Compounds of redox reversible fluorescent probe 200 can have a chiral center, As a result, one may selectively prepare one optical isomer, including diastereomers and enantiomers, over another, e.g., by chiral starting materials, catalysts or solvents, or can prepare both stereoisomers or both optical isomers, including diastereomers and enantiomers at once (a racemic mixture). Since compounds of redox reversible fluorescent probe 200 can exist as racemic mixtures, mixtures of optical isomers, including diastereomers and enantiomers, or stereoisomers can be separated using known methods, such as through the use of, e.g., chiral salts and chiral chromatography.

In addition, it is recognized that one optical isomer, including a diastereomer and enantiomer, or a stereoisomer, can have favorable properties over the other. When a racemic mixture is discussed herein, it is clearly contemplated to include both optical isomers, including diastereomers and enantiomers, or one stereoisomer substantially free of the other.

Compounds of redox reversible fluorescent probe 200 also include all energetically accessible conformational and torsional isomers of the compounds disclosed,

Monitoring a single-electron transfer reaction of Redox reversible fluorescent probe 200 is contemplated. In an embodiment, Redox reversible fluorescent probe 200 is dissolved in a composition that includes acetonitrile and lithium perchlorate as an electrolyte to provide a selected concentration, e.g., from 1 mmol L⁻¹ to 5 mmol Acetonitrile containing lithium perchlorate (electrolyte solution) in a selected amount (e.g., 5 mL) is disposed in a 3-electrode electrochemical cell. The electrochemical cell can include a glassy-carbon working electrode, a silver/silver nitrate reference electrode, and a platinum counter electrode. A potentiostat applies a voltage ramp and measures a resulting current produced from the electron transfer reaction of redox reversible fluorescent probe 200. The composition in the electrochemical cell is degassed by flowing a stream of inert gas, e.g., argon or nitrogen, through a i-mm inner-diameter polytetrafluoroethylene tubing into the electrochemical solution. The stream of inert gas is maintained such that the composition in the electrochemical cell does not evaporate. The composition in the electrochemical cell is degassed, e.g., for 5 minutes after which time, the stream of gas is directed to a headspace in the electrochemical cell to provide inert gas over the composition. Prior to injection of the composition of Redox reversible fluorescent probe 200 into the electrochemical cell, voltage cycles are applied to the electrochemical cell. The voltage is swept, e.g., from −1.2 V to +1.0 V vs. Ag/AgNO₃ reference and back again while the current is recorded to produce a cyclic voltammogram. An aliquot of the composition of Redox reversible fluorescent probe 200 in acetonitrilellithium perchlorate is added via a glass-tight syringe to the electrolyte composition contained in the electrochemical cell to produce a final concentration of 200 of 500 μmol L⁻¹ to 1 mM L⁻¹. A cyclic voltanimogram of Redox reversible fluorescent probe 200 is acquired to show the voltage at which the electron transfer event occurs. For Redox reversible fluorescent probe 200, the electron transfer is an oxidation of Fe²⁺ to Fe³⁺.

To monitor fluorescence of Redox reversible fluorescent probe 200 before and after redox switching, a composition of Redox reversible fluorescent probe 200 in acetonitrile and lithium perchlorate is placed in an electrochemical cell constructed in a cuvette in a fluorimeter. The working electrode is platinum mesh; the reference electrode is a chlorided silver wire. The counter electrode is a platinum wire. The fluorimeter is set to deliver an excitation wavelength of 516 nm. The resulting emission spectrum is collected from 525 nm to 600 nm. An emission spectrum is collected prior to applying a voltage to the solution of Redox reversible fluorescent probe 200. A voltage at least 50 mV higher than the voltage at which electron transfer (oxidation) is observed is applied to the solution. The emission intensity at 540 nm is monitored over time as the voltage that is sufficient to induce electron transfer is applied.

Redox reversible fluorescent probe 200 and processes herein have numerous advantageous and unexpected benefits and uses. In an embodiment, a process for performing single-electron transfer fluorescence probing includes: contacting an analyte with redox reversible fluorescent probe 200 by combining the analyte and redox reversible fluorescent probe 200 in acetonitrile containing lithium perchlorate; forming a probe-analyte complex from redox reversible fluorescent probe 200 and the analyte in response to contacting the analyte with redox reversible fluorescent probe 200 by mixing the analyte and redox reversible fluorescent probe 200 in acetonitrile containing lithium perchlorate, the probe-analyte complex including redox reversible fluorescent probe 200 connected to the analyte; subjecting the probe-analyte complex to probe radiation by using a mercury halogen lamp, the probe radiation can include a wavelength selected to be resonant or near-resonant with an electronic transition in redox reversible fluorescent probe 200 of the probe-analyte complex; electronically exciting the redox reversible fluorescent probe 200 in the probe-analyte complex in response to subjecting the probe-analyte complex to the probe radiation by using a mercury halogen lamp; switching the redox state of redox reversible fluorescent probe 200 in the probe-analyte complex by applying a voltage; and determining, from the fluorescence from redox reversible fluorescent probe 200 in the probe-analyte complex, the redox state of the analyte to perform single-electron transfer fluorescence probing by monitoring the fluorescence intensity of the redox reversible fluorescent probe 200 over time.

It should be appreciated that redox reversible fluorescent probe 200 and performing single-electron transfer fluorescence probing can be used for monitoring and imaging of oxidative electrocatalysis. Here, a solution of redox reversible fluorescent probe 200 is applied to the electrocatalyst and the fluorescence of redox reversible fluorescent probe 200 is monitored while a voltage ramp is applied to the electrocatalyst. The fluorescence of redox reversible fluorescent probe 200 decreases as the electrocatalyst is oxidized.

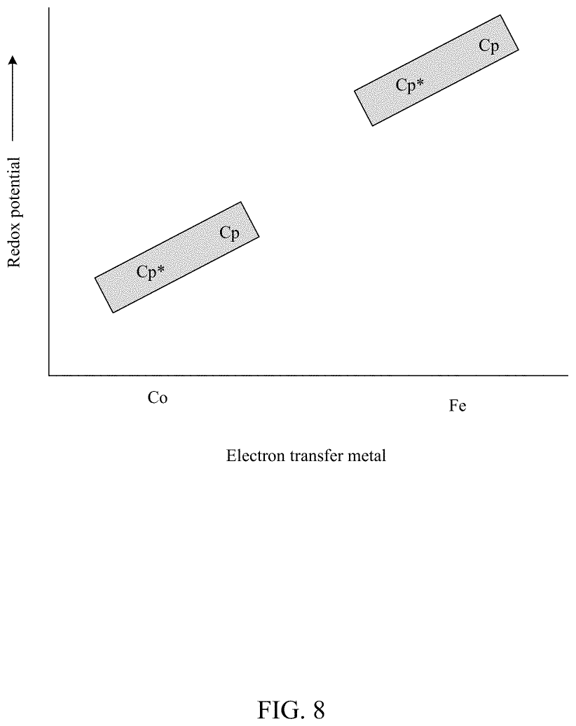

Redox reversible fluorescent probe 200 and processes disclosed herein have numerous beneficial uses, including in situ monitoring of electrocatalytic oxidation, fluorescence imaging of redox processes on catalyst surfaces, and solubility in non-polar organic solvents, excitation and fluorescence in the visible wavelength range. Advantageously, redox reversible fluorescent probe 200 and performing single-electron transfer fluorescence probing overcome limitations of technical deficiencies of conventional compositions such as monitoring redox changes in aqueous solutions. Further, Redox reversible fluorescent probe 200 can be cycled from a fluorescent to a non-fluorescent state repeatedly unlike conventional redox-sensing fluorophores that undergo irreversible chemical changes upon redox state change. Moreover, FIG. 8 shows that redox potential adjustment that are selectively tailorable based upon a species of electron transfer metal 203 and terminal moiety 205 or bridge moiety 204 that are provided in redox reversible fluorescent probe 200,

The articles and processes herein are illustrated further by the following Examples, which are non-limiting.

### EXAMPLES

### Example 1

### Single Electron Transfer in Redox Reversible Fluorescent Probe

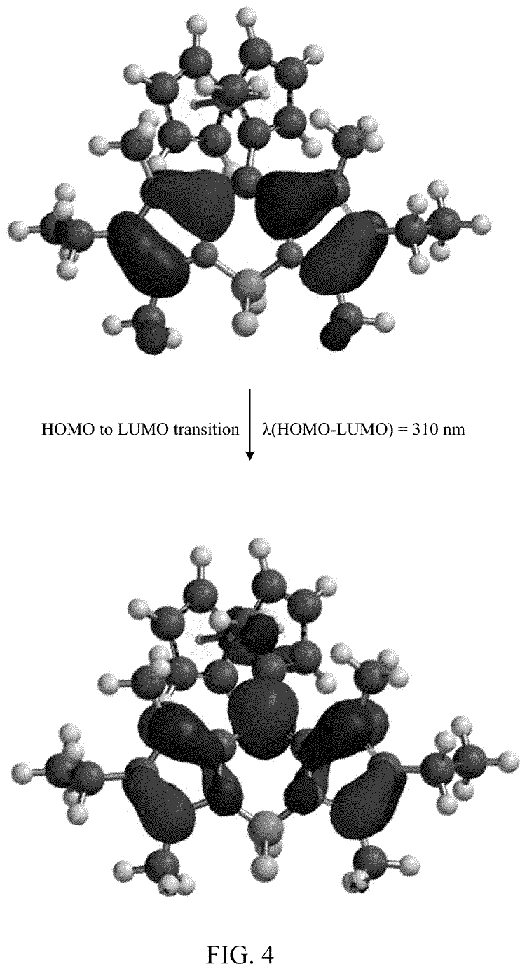

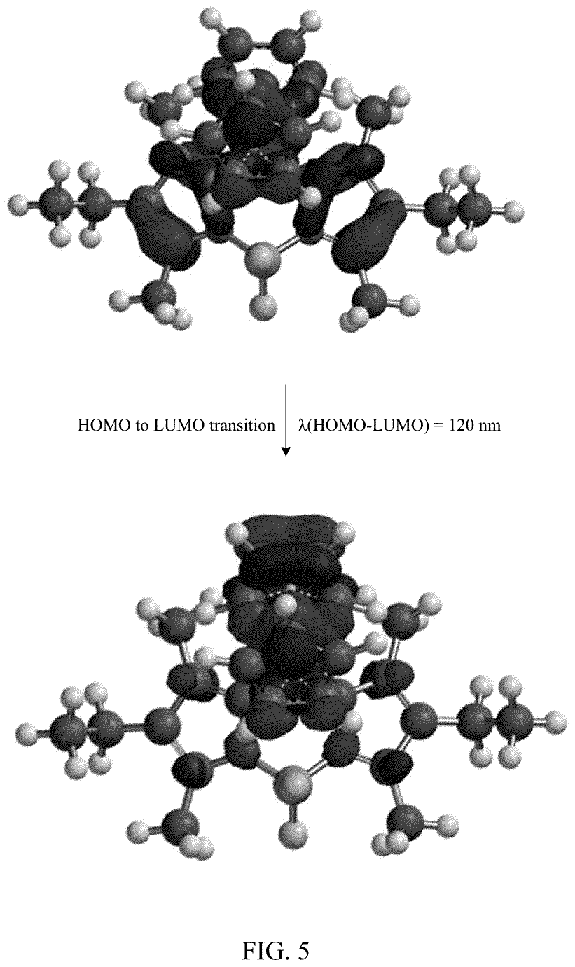

FIG. 4 shows simulated orbitals from density functional theory (INT) calculations in vacuum for the highest energy electron orbital (HOMO) to the lowest energy unoccupied orbital (LUMO) when the redox moiety maintains a neutral charge. The orbitals remained confined to the fluorescent center. FIG. 5 shows simulated orbitals using DIET in vacuum for the HOMO and LUMO when the redox moiety maintains a positive charge. The electron orbitals are pulled into the redox moiety structure at higher energy outside the visible spectrum of light and quenching fluorescence.

### Example 2

### Selectively Tailoring Fluorescence From Redox Reversible Fluorescent Probe for Single-Electron Transfer Fluorescence Probing

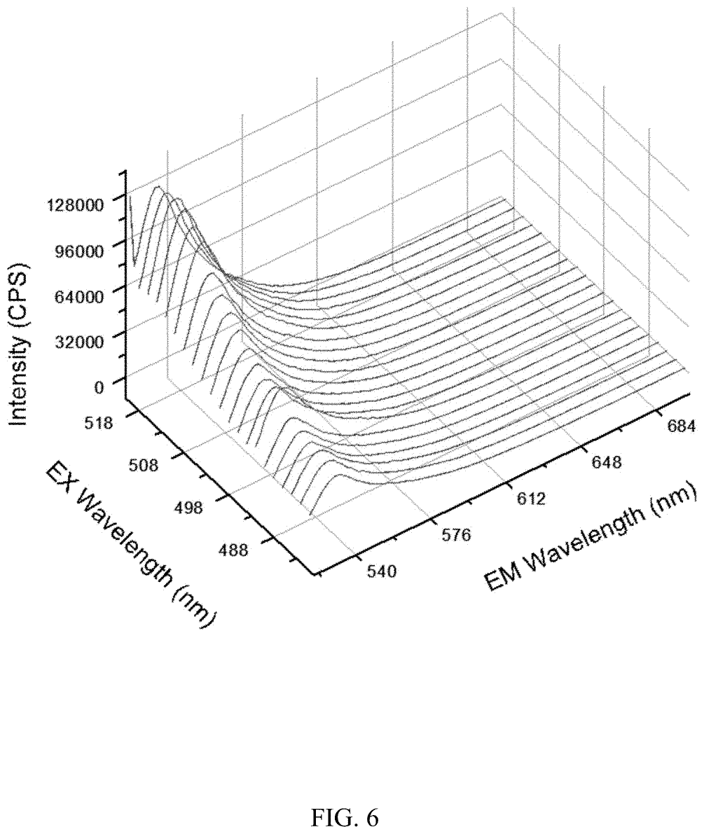

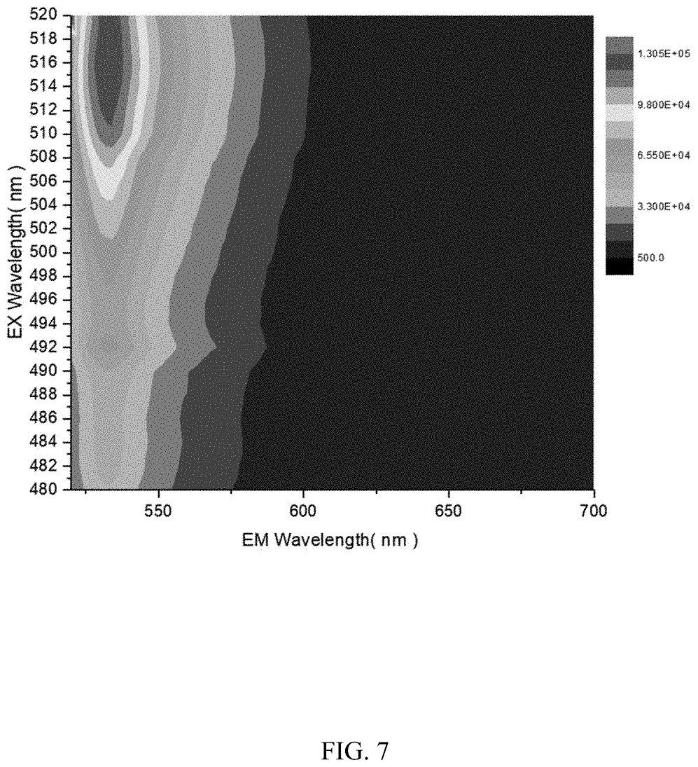

FIG. 6 shows emission spectra as a function of excitation wavelength showing a maximum fluorescence intensity with excitation of 516 nm. FIG. 7 is a plot with the false color representing intensity showing a maximum fluorescence emission at 540 nm with an excitation of 516 nm when the probe is active.

While one or more embodiments have been shown and described, modifications and substitutions may be made thereto without departing from the spirit and scope of the invention. Accordingly, it is to be understood that the present invention has been described by way of illustrations and not limitation. Embodiments herein can be used independently or can be combined.

All ranges disclosed herein are inclusive of the endpoints, and the endpoints are independently combinable with each other. The ranges are continuous and thus contain every value and subset thereof in the range. Unless otherwise stated or contextually inapplicable, all percentages, when expressing a quantity, are weight percentages. The suffix “(s)” as used herein is intended to include both the singular and the plural of the term that it modifies, thereby including at least one of that term (e.g., the colorant(s) includes at least one colorants). “Optional” or “optionally” means that the subsequently described event or circumstance can or cannot occur, and that the description includes instances where the event occurs and instances where it does not. As used herein, “combination” is inclusive of blends, mixtures, alloys, reaction products, and the like.

As used herein, “a combination thereof” refers to a combination comprising at least one of the named constituents, components, compounds, or elements, optionally together with one or more of the same class of constituents, components, compounds, or elements.

All references are incorporated herein by reference.

The use of the terms “a” and “an” and “the” and similar referents in the context of describing the invention (especially in the context of the following claims) are to be construed to cover both the singular and the plural, unless otherwise indicated herein or clearly contradicted by context. “Or” means “and/or.” It should further be noted that the terms “first,” “second,” “primary,” “secondary,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity). The conjunction “or” is used to link objects of a list or alternatives and is not disjunctive; rather the elements can be used separately or can be combined together under appropriate circumstances.

What is claimed is:

1. A redox reversible fluorescent probe for performing single-electron transfer fluorescence probing, the redox reversible fluorescent probe comprising:
a redox moiety comprising:
a terminal moiety;
an electron transfer metal coordinatively bonded to the terminal moiety; and
a bridge moiety coordinatively bonded to the electron transfer metal; and
a fluorescent moiety covalently bonded to the bridge moiety of the redox moiety and comprising:
an electron bandgap mediator that is covalently bonded to the bridge moiety;
a coordinate center covalently bonded to the electron bandgap mediator and that forms a Zwitterionic member with an atom in the electron bandgap mediator; and
a steric hinder bonded to the electron bandgap mediator to provide steric hindrance for protection of the coordinate center.

2. The redox reversible fluorescent probe of claim 1, wherein the coordinate center comprises boron such that the boron is covalently bonded to the electron bandgap mediator.

3. The redox reversible fluorescent probe of claim 2, wherein the coordinate center further comprises fluorine, and the fluorine is bonded to the boron.

4. The redox reversible fluorescent probe of claim 1, wherein the coordinate cent comprises: 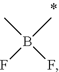
wherein * is a point of attachment to the electron bandgap mediator.

5. The redox reversible fluorescent probe of claim 1, wherein the electron bandgap mediator comprises: 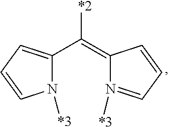
wherein *2 is a point of attachment to the bridge moiety, and *3 are points of attachment to the coordinate center.

6. The redox reversible fluorescent probe of claim 1, wherein the steric hinder comprises an alkyl group.

7. The redox reversible fluorescent probe of claim 1, wherein the electron bandgap mediator and the steric hinder of the fluorescent moiety in combination comprise: 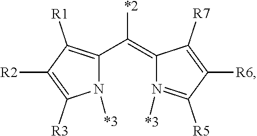
wherein:
*2 is a point of attachment to the bridge moiety;
*3 are points of attachment to the coordinate center; and
R1, R2, R3, R5, R6, and R7 are independently H, an alkyl group, an alkenyl group, an alkynyl group, a hydroxyalkyl group, or substituted version thereof, or substituted alkyl group; or
any of R1, R2, R3, R5, R6, and R7, together with the carbon atom to which they are attached, forms a monocycle ring, a bicyclic ring, or a spirocyclic ring that optionally contains a heteroatom, and is optionally substituted, such that if present the monocycle ring, the bicyclic ring, or the spirocyclic ring optionally extends conjugation of the electron bandgap mediator.

8. The redox reversible fluorescent probe of claim 1, wherein the electron bandgap mediator and the steric hinder of the fluorescent moiety in combination comprise: 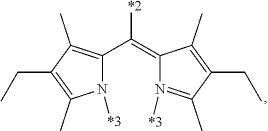
wherein *2 is a point of attachment to the bridge moiety, and *3 are points of attachment to the coordinate center.

9. The redox reversible fluorescent probe of claim 1, wherein the electron bandgap mediator, the steric hinder, and the coordinate center of the fluorescent moiety in combination comprise: 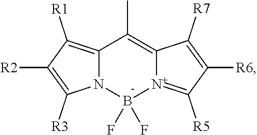
wherein:
* is a point of attachment to the bridge moiety; and
R1, R2, R3, R5, R6, and R7 are independently H, air alkyl group, alkenyl group, alkynyl group, hydroxyalkyl group, or substituted version thereof; or
any of R1, R2, R3, R5, R6, and R7, together with the carbon atom to which they are attached, forms a monocydic ring, a bicyclic ring, or a spirocyclic ring that optionally contains a heteroatom, and is optionally substituted, such that if present the monocyclic ring, the bicyclic ring, or the spirocyclic ting optionally extends conjugation of the electron bandgap mediator.

10. The redox reversible fluorescent probe of claim 1, wherein the electron bandgap mediator and the steric hinder of the fluorescent moiety in combination comprise: 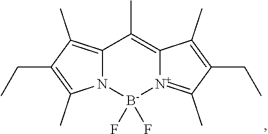
wherein * is a point of attachment to the bridge moiety.

11. The redox reversible fluorescent probe of claim 1, wherein the bridge moiety comprises: 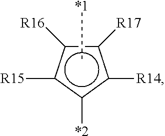
wherein:
*1 is a point of attachment to the electron transfer metal;
*2 are points of attachment to the fluorescent moiety; and
R14, R15, R16, and R17 are independently H, an alkyl group, an alkenyl group, an alkynyl group, a hydroxyalkyl group, or substituted version thereof; or
any of R14, R15, R16, and R17, together with the carbon atom to which they are attached, forms a monocyclic ring, a bicyclic ring, or a spirocyclic ring that optionally contains a heteroatom, and is optionally substituted.

12. The redox reversible fluorescent probe of claim 11, wherein R14, R15, R16, and R17 are independently H or CH₃.

13. The redox reversible fluorescent probe of claim 12, wherein the bridge moiety is 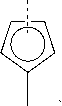
and
the electron bandgap mediator and the steric hinder of the fluorescent moiety in combination comprise: 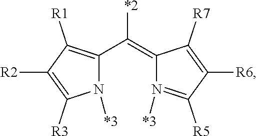
wherein:
*2 is a point of attachment to the bridge moiety;
*3 are points of attachment to the coordinate center; and
R1, R2, R3, R5, R6, and R7 are independently H, an alkyl group, alkenyl group, alkynyl group, hydroxyalkyl group, or substituted version thereof; or
any of R1, R2, R3, R5, R6, and R7, together with the carbon atom to which they are attached, forms a monocyclic ring, a bicyclic ring, or a spirocyclic ring that optionally contains a heteroatom, and is optionally substituted, such that if present the monocyclic ring, the bicyclic ring, or the spirocydic ring optionally extends conjugation of the electron bandgap mediator.

14. The redox reversible fluorescent probe of claim 13, wherein the electron bandgap mediator and the steric hinder of the fluorescent moiety in combination comprise: 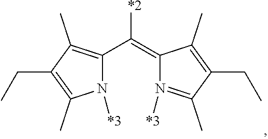
wherein *2 is a point of attachment to the bridge moiety, and *3 are points of attachment to the coordinate center.

15. The redox reversible fluorescent probe of claim 13, wherein the electron bandgap mediator, the steric hinder, and the coordinate center of the fluorescent moiety in combination comprise:

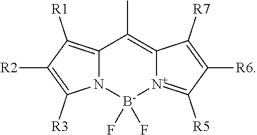

16. The redox reversible fluorescent probe of claim 15, wherein the electron bandgap mediator and the steric hinder of the fluorescent moiety in combination comprise: 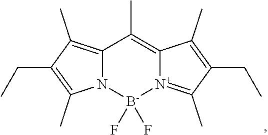
wherein * is a point of attachment to the bridge moiety.

17. The redox reversible fluorescent probe of claim 1, wherein the terminal moiety comprises: 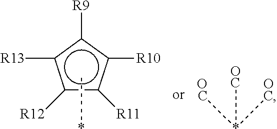
wherein:
* is a point of attachment to the electron transfer metal;
R9, R10, R11, R12, and R13 are independently H, an alkyl group, an alkenyl group, an alkynyl group, a hydroxyalkyl group, or a substituted version thereof; or
any of R9, R10, R11, R12, and R13, together with the carbon atom to which they are attached, forms a monocyclic ring, a bicyclic ring, or a spirocyclic ring that optionally contains a heteroatom, and is optionally substituted;
the bridge moiety comprises: 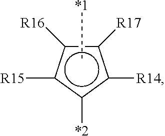
wherein:
*1 is a point of attachment to the electron transfer metal;
*2 are points of attachment to the fluorescent moiety; and
R14, R15, R16, and R17 are independently H, an alkyl group, an alkenyl group, an alkynyl group, a hydroxyalkyl group, or substituted version thereof; or
any of R14, R15, R16, and R17, together with the carbon atom to which they are attached, forms a monocyclic ring, a bicyclic ring, or a spirocyclic ring that optionally contains a heteroatom, and is optionally substituted;
the electron bandgap mediator and the steric hinder of the fluorescent moiety in combination comprise: 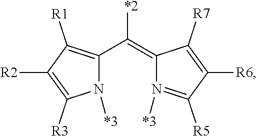
wherein:
*2 is a point of attachment to the bridge moiety;
*3 are points of attachment to the coordinate center; and
R1, R2, R3, R5, R6, and R7 are independently an alkyl group, alkenyl group, alkynyl group, hydroxyalkyl group, or substituted version thereof; or
any of R1, R2, R3, R5, R6, and R7, together with the carbon atom to which they are attached, forms a monocyclic ring, a bicyclic ring, or a spirocyclic ring that optionally contains a heteroatorn, and is optionally substituted, such that if present the monocyclic ring, the bicyclic ring, or the spirocyclic ring optionally extends conjugation of the electron bandgap mediator; and
the electron transfer metal comprises Fe, Co, or Cr.

18. The redox reversible fluorescent probe of claim 17, wherein R14, R15, R16, and R17 are independently H or CH₃.

19. The redox reversible fluorescent probe of claim 18, wherein the bridge moiety is

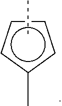

20. The redox reversible fluorescent probe of claim 17, wherein the electron bandgap mediator, the steric hinder, and the coordinate center of the fluorescent moiety in combination comprise:

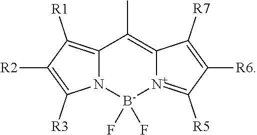

21. The redox reversible fluorescent probe of claim 20, wherein the electron bandgap mediator and the steric hinder of the fluorescent moiety in combination comprise:

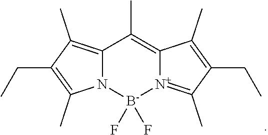 [SMILES: CCC1=C(C)C2=C(C)c3c(C)c(CC)c(C)n3[B-](F)(F)[N+]2=C1C]

22. The redox reversible fluorescent probe of claim 17, wherein the redox reversible fluorescent probe is

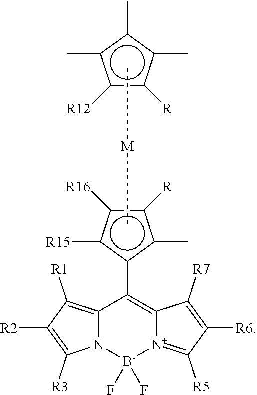

23. The redox reversible fluorescent probe of claim 17, wherein the redox reversible fluorescent probe is [chemical structure]
